(19) United States
(12) Patent Application Publication
(10) Pub. No.: US 2010/0143194 A1
(43) Pub. Date: Jun. 10, 2010

(54) MICROFLUIDIC DEVICE

(75) Inventors: Dae-Sik Lee, Daejeon (KR); Yo Han Choi, Daejeon (KR); Kwang Hyo Chung, Daejeon (KR); JuHyun Jeon, Daejeon (KR); Hyun Woo Song, Daejeon (KR); Moon Youn Jung, Daejeon (KR); Seon Hee Park, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/493,092

(22) Filed: Jun. 26, 2009

(30) Foreign Application Priority Data
Dec. 8, 2008 (KR) 10-2008-0124028
Mar. 27, 2009 (KR) 10-2009-0026261

(51) Int. Cl. B01J 19/00

(52) U.S. Cl. 422/68.1

(57) ABSTRACT

Provided is a microfluidic device. The microfluidic device includes a sample storage chamber storing sample fluid therein, a detection chamber connected to the sample storage chamber and detecting a specific material of the sample fluid, a cleaning liquid storage chamber connected to the detection chamber and storing cleaning liquid therein, a plurality of fluid passages interconnecting the chambers, and a micropump transferring the cleaning liquid. The microfluidic device precisely inspects a sample fluid although a small amount of the sample fluid flows.

### CROSS-REFERENCE TO RELATED APPLICATIONS

This U.S. non-provisional patent application claims priority under 35 U.S.C. §119 of Korean Patent Application No. 10-2008-0124028, filed on Dec. 8, 2008, and Korean Patent Application No. 10-2009-0026261, filed on Mar. 27, 2009, the entire contents of which are hereby incorporated by reference.

### BACKGROUND OF THE INVENTION

The present invention disclosed herein relates to a microfluidic device.

Microfluidic devices are variously applied to lab-on-a-chips such as protein chips, DNA chips, drug delivery systems, micro total analysis systems, and micro reactors that require precise and fine fluid controlling.

Typical microfluidic devices utilize flow of fluid based on capillary force. It is important for a microfluidic device to control the flow rate of a sample fluid for improving the sensitivity of the microfluidic device to a particular substance included in the sample fluid. To this end, a variety of methods have been researched. However, typical microfluidic devices require a large amount of sample fluid and have some limitations in controlling the flow rate of the sample fluid.

### SUMMARY OF THE INVENTION

The present invention provides a microfluidic device that can perform accurate test using a relatively small amount of sample fluid.

The present invention also provides a microfluidic device that can sequentially control flow of sample fluid.

Embodiments of the present invention provide microfluidic devices include a sample storage chamber storing sample fluid therein; a detection chamber connected to the sample storage chamber and detecting a specific material of the sample fluid; a cleaning liquid storage chamber connected to the detection chamber and storing cleaning liquid therein; a plurality of fluid passages interconnecting the chambers; and a micropump transferring the cleaning liquid.

In some embodiments, the micropump may generate gas. At this point, the micropump may include water in an enclosed microtank; and citric acid and carbonate around the microtank, and the microtank may be formed of a paraffin film. The microfluidic devices may further include a microheater adjacent to the micropump and applying heat to the micropump. The microfluidic devices may further include a temperature sensor adjacent to the microheater.

In still other embodiments, the microfluidic devices may further include a waste chamber to which the cleaning liquid and the sample fluid transferred by the micropump are abandoned.

In even other embodiments, the microfluidic devices may further include upper plate and lower plate contacting each other and provided with a groove defining the chambers and fluid passages and a lower end of the upper plate is fused or bonded to the lower plate. At least one of the upper plate and lower plate may be formed of at least one material selected from the group consisting of cyclo olefin copolymer (COC), polymethylmethacrylate (PMMA), polycarbonate (PC), cyclo olefin polymer (COP), liquid crystalline polymers (LCP), polydimethylsiloxane (PDMS), polyamide (PA), polyethylene (PE), polyimide (PI), polypropylene (PP), polyphenylene ether (PPE), polystyrene (PS), polyoxymethylene (POM), polyetheretherketone (PEEK), polyethylenephthalate (PES), polyethylenephthalate (PET), polytetrafluoroethylene (PTFE), polyvinylchloride (PVC), polyvinylidene fluoride (PVDF), polybutyleneterephthalate (PBT), fluorinated ethylenepropylene (FEP), and perfluoralkoxyalkane (PFA).

In yet other embodiments, the microfluidic devices may further include a filter between the storage chamber and the passage.

In further embodiments, the passage may be hydrophilic-treated or hydrophobic-treated to control a flow rate of the sample fluid.

In still further embodiments, the microfluidic devices may further include a valve part having an internal surface having a greater width than the fluid passage or hydrophobic-treated. The microfluidic devices may further include a valve part having an internal surface which has a greater width than the fluid passage and is hydrophobic-treated. The valve part may be located at least an end of the detection chamber.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a top plan view of a microfluidic device according to an embodiment of the present invention;

FIG. 2A is a top plan view of a lower plate of FIG. 1;

FIG. 2B is a top plan view of an upper plate of FIG. 1;

FIG. 3 is a cross-sectional view taken along line I-I′ of FIG. 1;

FIG. 4A is a cross-sectional view taken along line II-II′ of FIG. 1 according to one embodiment;

FIG. 4B is a cross-sectional view taken along line II-II′ of FIG. 1 according to another embodiment;

FIG. 5A is a cross-sectional view taken along line III-III′ of FIG. 1 according to an embodiment;

FIG. 5B is a cross-sectional view taken along line III-III′ of FIG. 1 according to another embodiment; and

FIGS. 6A, 6B, and 6C are top plan views sequentially illustrating a flow of fluid in the microfluidic device of FIG. 1.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

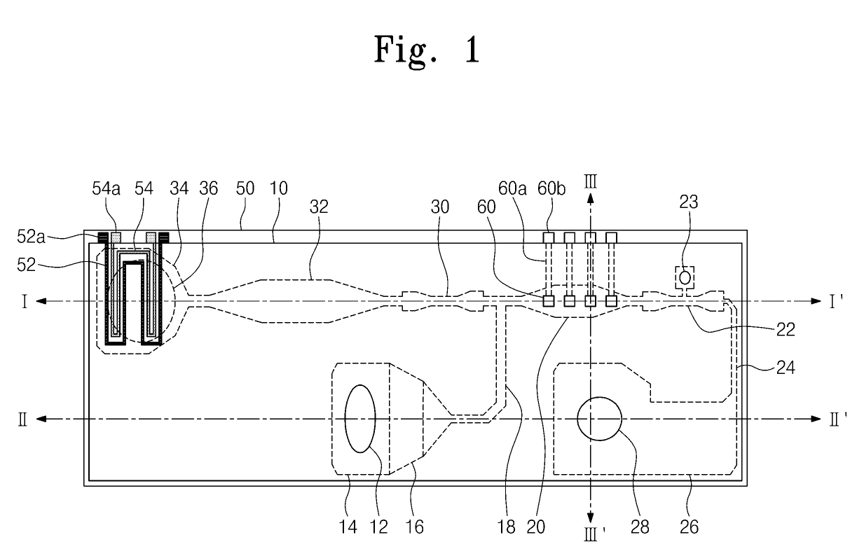

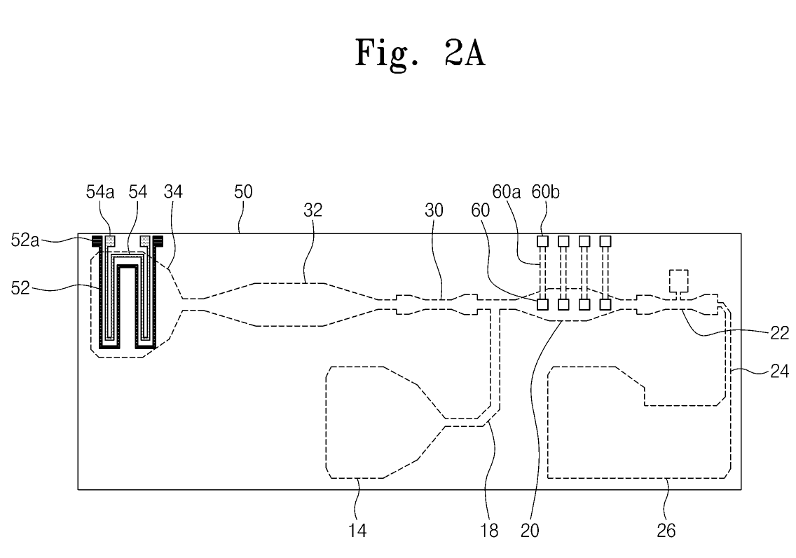

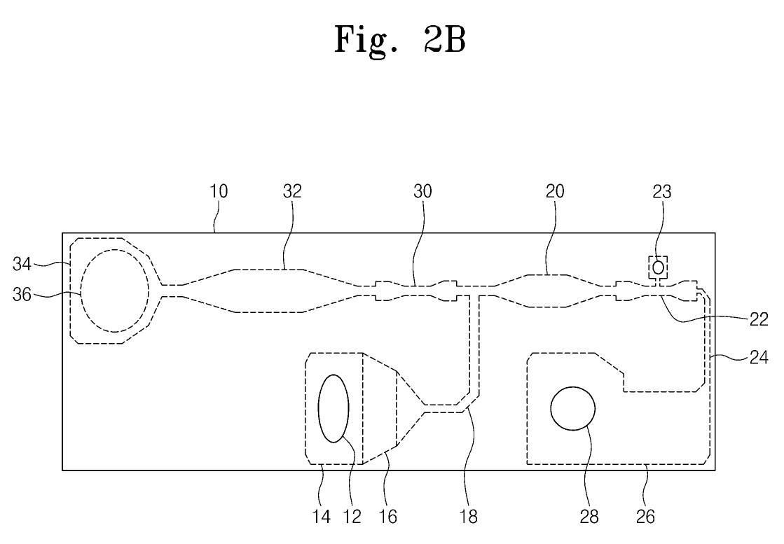

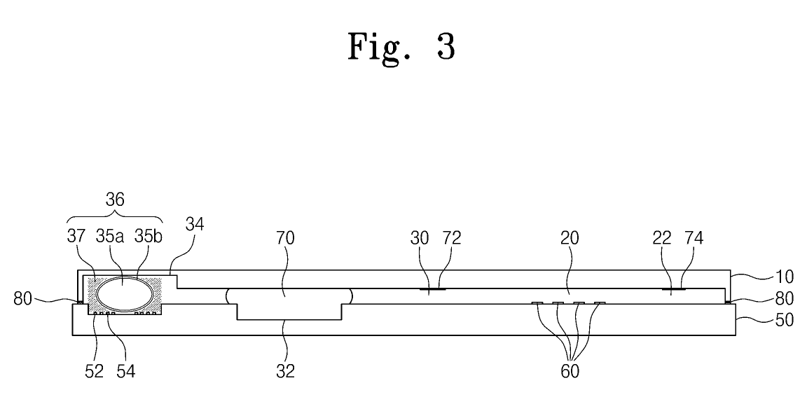

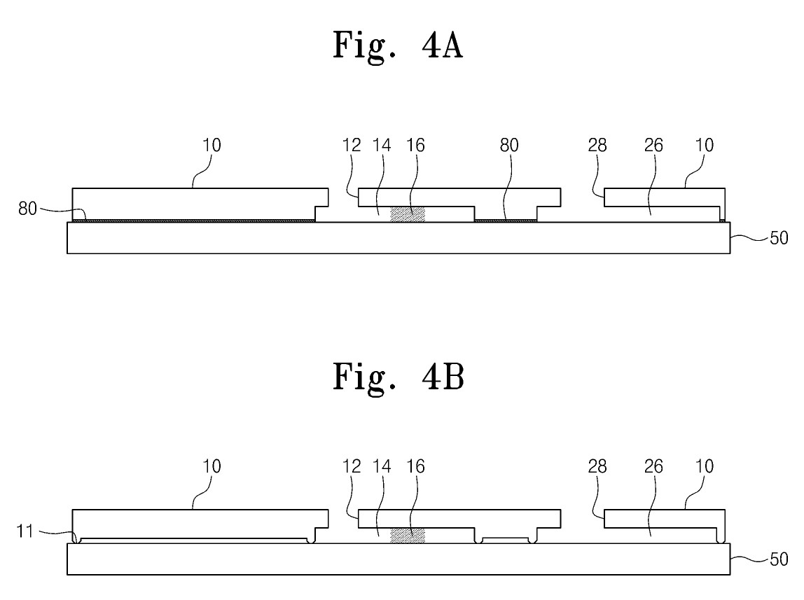

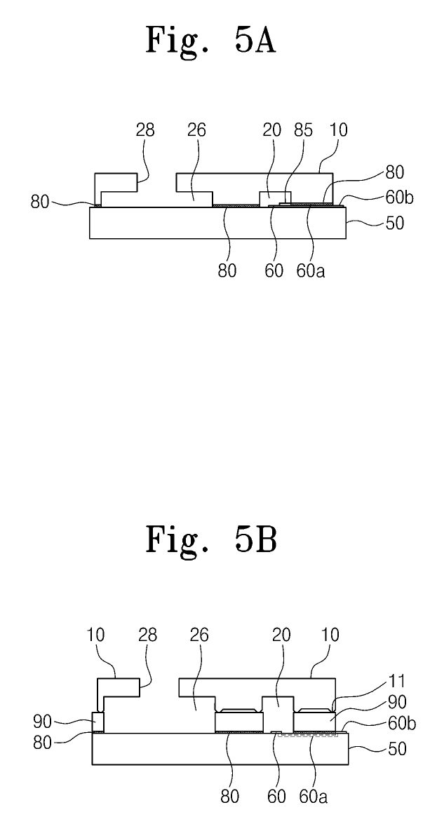

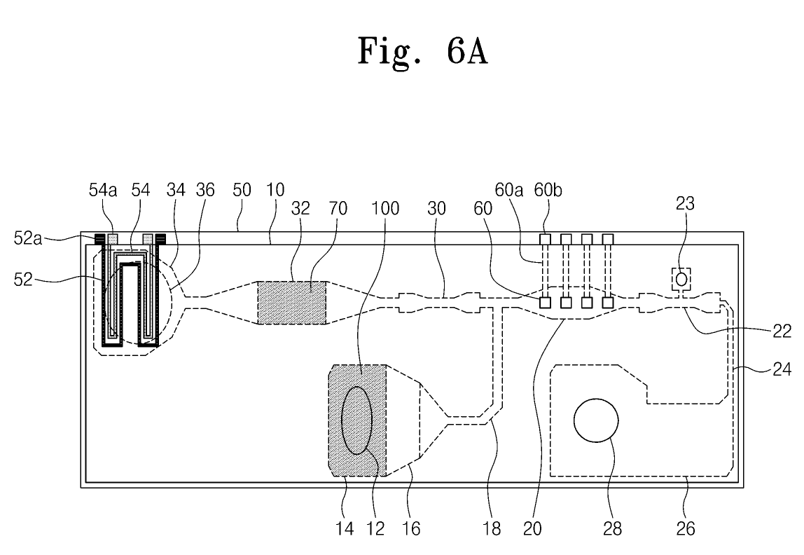

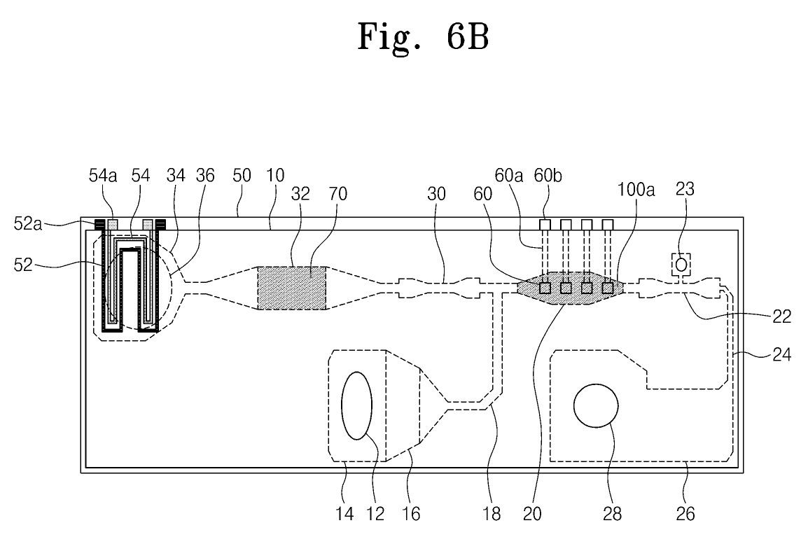

FIG. 1 is a top plan view of a microfluidic device according to an embodiment of the present invention, FIG. 2A is a top plan view of a lower plate of FIG. 1, FIG. 2B is a top plan view of an upper plate of FIG. 1, FIG. 3 is a cross-sectional view taken along line I-I′ of FIG. 1, FIG. 4A is a cross-sectional view taken along line II-II′ of FIG. 1 according to one embodiment, FIG. 4B is a cross-sectional view taken along line II-II′ of FIG. 1 according to another embodiment, and FIG. 5A is a cross-sectional view taken along line III-III′ of FIG. 1 according to an embodiment.

Referring to FIGS. 1, 2A, 2B, 3, 4A, and 5A, a microfluidic device of the current embodiment includes upper plate and lower plate 10 and 50. The upper plate and lower plate 10 and 50 are engaged with each other. Chambers 14, 20, 26, 32, and 34, fluid passages 18 and 24, and valve parts 22 and 30 are defined by grooves on the lower plate 50. The chambers 14, 20, 26, 32, and 34 may be referred to as a sample storage chamber 14, a detection chamber 20 detecting a specific material in the sample fluid, a cleaning liquid storage chamber 32 storing cleaning liquid therein, a micropump chamber 34 storing a micropump 36 therein, and a waste chamber 26 to which the cleaning liquid and the sample fluid are abandoned. The cleaning liquid storage chamber 32 is disposed between the micropump chamber 34 and the detection chamber 20. The valve parts 22 and 30 may be referred to as a first valve part 22 disposed between the detection chamber 20 and the waste chamber 26 and a second valve part 30 disposed between the cleaning liquid storage chamber 32 and the detection chamber 20. The fluid passages 18 and 24 may be referred to as a first fluid passage 18 interconnecting the sample storage chamber 14 and the detection chamber 20 and a second fluid passage 24 interconnecting the second valve part 30 and the waste chamber 26.

Formed through the upper plate 10 of the sample storage chamber 14 is an inlet through which the sample fluid is introduced. A filter 16 is disposed between the sample storage chamber 14 and the first fluid passage 18. The valve parts 22 and 30 have the greater width than the fluid passages 18 and 24. The valve parts 22 and 30 have hydrophobic-treated regions 72 and 74. The valve parts 22 and 30 may be formed in a ribbon shape when viewed from the top. That is, the valve parts 22 and 30 may include two regions having the greater width than the fluid passages 18 and 24 and the hydrophobic-treated region 72 located between the two regions. An air vent 23 may be connected to the first valve part 22.

Referring to FIGS. 1, 2A, and 3, the micropump 36 is located in the micropump chamber 34. The micropump 36 generates gas to increase internal pressure of the micropump chamber 34 and to thereby forcedly transfer the cleaning liquid 70. The micropump chamber 34 includes water 35a contained in an enclosed microtank 35b and a mixture material 37 located out of the microtank 35b. The mixture material 37 includes citric acid and carbonate. The microtank 35b may be formed of a paraffin film. Therefore, the microtank 35b may be melted by heat. As the paraffin film is melted, the water contained in the microtank 35b flows out and thus the citric acid and carbonate are dissolved in the water. At this point, the citric acid and the carbonate react to each other to generate gas such as carbon dioxide. A microheater 52 is disposed on the lower plate 50 under the micropump chamber 34. The microheater 52 generates the heat for melting the paraffin film. A temperature sensor may be disposed adjacent to the microheater 52 on the lower plate 50. Terminals 52a and 54a of the microheater 52 and temperature sensor 54 are not covered with the upper plate 10 but disposed on the lower plate 50 and exposed to an external side. Surfaces of the microheater 52 and temperature sensor 54 may not be in contact with the micropump 36 but covered with a protective film (not shown). At this point, the heat generated by the microheater 52 may be transferred to the micropump 36 through the protective film.

Referring to FIGS. 1, 2A, 3, and 5A, at least one detection electrode 60 may be disposed on the lower plate 50 of the detection chamber 20. For example, a capture antibody capturing a detector antibody on which gold nano-particles are fixed may be applied on the detection electrode 60. The more the detector antibody on which the gold nano-particles are fixed and which are captured by the detection electrode 60, the higher the electrical conductivity. With this property, the specific material can be detected and read. In accordance with the application purpose, a variety of biochemical materials such as proteins (e.g., antigen and antibody) and gene may be fixed on the detection electrode 120. The detection electrode 120 may be surface treated with, for example, a self-assembled monolayer). If necessary, a variety of chemical materials including dendrimer may be preformed on the detection electrode 120.

By sufficiently increasing an amount of the sample fluid collected in the detection chamber 20, the sensitivity of the detection electrode 60 may be improved. To this end, as shown in FIG. 5B, an intermediate plate 90 may be inserted between the upper plate and lower plate 10 and 50.

The detection electrode 60 is connected to an electrode connecting portion 60a and the electrode terminal 60b that is not covered with the upper plate 10 but exposed to an external side. The electrode connecting portion 60a may be exposed to the external side. However, in order to reduce a nonspecific biological defect, the electrode connecting portion 60a may be covered with a protective layer as shown in FIG. 5A or disposed in the lower plate 50 as shown in FIG. 5B. A terminal of the microheater 52, a terminal of the temperature sensor 54, and a terminal 60b of the detection electrode 60 may be connected to a power unit or a measuring portion of an external measuring device.

At least one of the upper plate and lower plate 10 and 50 may be formed of a material selected from the group consisting of cyclo olefin copolymer (COC), polymethylmethacrylate (PMMA), polycarbonate (PC), cyclo olefin polymer (COP), liquid crystalline polymers (LCP), polydimethylsiloxane (PDMS), polyamide (PA), polyethylene (PE), polyimide (PI), polypropylene (PP), polyphenylene ether (PPE), polystyrene (PS), polyoxymethylene (POM), polyetheretherketone (PEEK), polyethylenephthalate (PES), polyethylenephthalate (PET), polytetrafluoroethylene (PTFE), polyvinylchloride (PVC), polyvinylidene fluoride (PVDF), polybutyleneterephthalate (PBT), fluorinated ethylenepropylene (FEP), perfluoralkoxyalkane (PFA), and a combination thereof. The upper plate and lower plate 10 and 50 may be manufactured through a typical mechanical process such as an injection molding process, a hot embossing process, a casting process, a stereolithography process, a laser ablation process, a rapid prototyping process, a silkscreen process, and a numerical control machining process or through a semiconductor processing method using photolithography and etching process. The upper plate and lower plate 10 and 50 may be attached to each other by an adhesive 80. The adhesive 80 may be a liquid type adhesive, a powder type adhesive, or a thin film type adhesive such as paper. In order to prevent the denaturation of the biochemical material such as the captive antibody on a surface of the detection electrode 60 during the attachment process of the upper plate and lower plate 10 and 50, the upper plate and lower plate 10 and 50 may be attached to each other at a normal or low temperature. In this case, a pressure sensitive adhesive that can work only by pressure may be used. When the upper plate and lower plate 10 and 50 may be attached to each other at a normal or low temperature to prevent the denaturation of the biochemical material during the attachment process of the upper plate and lower plate 10 and 50, as shown in FIG. 4B, a fusion bonding or ultrasonic bonding process including forming an end portion 11 of the upper plate 10 in a sharp shape, applying an ultrasonic energy to the sharp portion to locally melt the upper plate 10, and allowing the upper plate 10 to closely contact the lower plate 50. Alternatively, as shown in FIG. 5B, both the adhesive and the fusion bonding process may be used to attach the plates 10, 50, and 90 to each other.

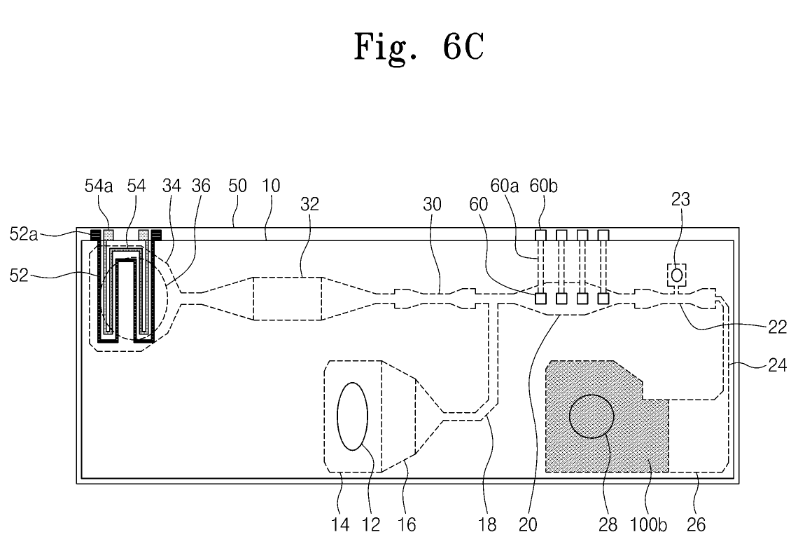

The following will describe a sequential flow of the fluid in the microfluidic device of FIG. 1 with reference to FIGS. 6A, 6B, and 6C.

Referring first to FIG. 6A, the sample fluid 100 is input through the inlet 12. When the sample fluid 100 is input, the antigen or antibody to which indicative factors that relate to the biochemical reaction such as the antigen/antibody reaction are fixed can be input together with the sample fluid 100. For example, the sample fluid may be blood. When the sample fluid 100 is input, the detector antibody to which the gold nano-particles may be input together. The cleaning liquid 70 is pre-stored in the cleaning liquid storage chamber 32.

Referring to FIG. 6B, when the sample fluid 100 is input, the sample fluid 100 flows from the sample storage chamber 14 to the first fluid passage 18 through the filter 16 by the capillary action. The filter 16 filters off large particles contained in the sample fluid 100. For example, when the sample fluid is the blood, leukocytes and erythrocytes are filtered off by the filter 16 and small particles such as blood serums and detector antibody to which the gold nano-particles are fixed pass through the filter 16. The sample fluid 100a passing through the filter 16 is directed to the detection chamber 20 through the first passage 18. The sample fluid 100a is not directed to the cleaning liquid storage chamber 32 by the second valve part 30. This is because that a portion of the second valve part 30, which is connected to the first fluid passage 18, has the greater width than the first fluid passage 18 and thus the capillary force is weakened. Furthermore, when the sample fluid 100a is blood, the content of the blood is mostly water. Therefore, the sample fluid 100a cannot passes through the second valve part 30 since the property of the water that reacts against the hydrophobic of the hydrophobic-treated region 72 of the second valve part 30. The capture antibody to which the gold nano-particles are fixed is captured in the detection chamber 20 by the antigen/antibody reaction. The sample fluid 100a in the detection chamber 20 cannot be easily directed to the second fluid passage 24 by the first valve part 22. This is because that the first valve part 22 has the same structure as the second valve part 30 and thus has the same function as the second valve part 30. If the cleaning liquid 70 cannot receive additional force, the cleaning liquid 70 cannot be easily directed toward the detection chamber 20 by the second valve part 30.

Referring to FIG. 6C, when the antigen/antibody reaction sufficiently occurs in the detection chamber 20, current is applied to the microheater 52 by an electronic signal of the external measuring device and the microheater 52 generates heat to melt the paraffin film of the micropump 36. Then, the citric acid (C₆H₈O₇) and carbonate (NaHCO₃) are melted by the water supplied by the micropump 36 and reacted to each other to generate C₆H₇O₇Na, water (H₂O), and carbon dioxide (CO₂). The pressure of the micropump chamber 34 increases by the carbon dioxide generated and thus the cleaning liquid 70 is directed to the detection chamber 20 through the second valve part 30. The cleaning liquid 70 joins the sample fluid 100a in the detection chamber 20 and is then directed to the waste chamber 28. As a result, a mixture 110b of the cleaning liquid 70 and the sample fluid is stored in the waste chamber 28. As the cleaning liquid 70 is forcedly directed to the micropump 36 and cleans the reaction materials that are not participated in the reaction and are weakened in bonding with the detection electrode 60, the sensitivity of the detection electrode 60 can be improved. Therefore, the test can be accurately performed by using only a small amount of the sample fluid in the microfluidic device.

Although the microfluidic device of the embodiment includes the citric acid and carbonate to generate the carbon dioxide, the present invention is not limited to this. That is, the microfluidic device may include other materials to generate the carbon dioxide. In addition, it will be obvious to a person skilled in the art that the microfluidic device may be configured to generate other gases such as oxygen or nitrogen.

According to the embodiment, particles that deteriorate the sensitivity can be removed by the micropump after the biochemical reaction detecting a specific material in the sample fluid is performed in the detection chamber. As a result, the test can be accurately realized using a small amount of the sample fluid in the microfluidic device.

Further, the flow rate of the sample fluid can be controlled by the valve part. Particularly, since the valve part is located at least an end of the detection chamber, the time for which the sample fluid stays in the detection chamber is increased and thus the sensitivity can be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A microfluidic device comprising:
a sample storage chamber in which a sample fluid is put and stored;
a detection chamber connected to the sample storage chamber and detecting a specific material of the sample fluid;
a cleaning liquid storage chamber connected to the detection chamber and storing cleaning liquid therein;
a plurality of fluid passages interconnecting the chambers; and
a micropump transferring the cleaning liquid.

2. The microfluidic device of claim 1, wherein the micropump generates gas.

3. The microfluidic device of claim 2, wherein the micropump comprises:
water in an enclosed microtank; and
citric acid and carbonate around the microtank,
wherein the microtank is formed of a paraffin film.

4. The microfluidic device of claim 2, further comprising a microheater being adjacent to the micropump and applying heat to the micropump.

5. The microfluidic device of claim 2, further comprising a temperature sensor adjacent to the microheater.

6. The microfluidic device of claim 1, further comprising a waste chamber to which the cleaning liquid and the sample fluid transferred by the micropump are abandoned.

7. The microfluidic device of claim 1, further comprising upper plate and lower plate contacting each other and provided with a groove defining the chambers and fluid passages.

8. The microfluidic device of claim 7, wherein a lower end of the upper plate is fused or bonded to the lower plate.

9. The microfluidic device of claim 7, wherein at least one of the upper plate and lower plate is formed of at least one material selected from the group consisting of cyclo olefin copolymer (COC), polymethylmethacrylate (PMMA), polycarbonate (PC), cyclo olefin polymer (COP), liquid crystalline polymer (LCP), polydimethylsiloxane (PDMS), polyamide (PA), polyethylene (PE), polyimide (PI), polypropylene (PP), polyphenylene ether (PPE), polystyrene (PS), polyoxymethylene (POM), polyetheretherketone (PEEK), polyethylenephthalate (PES), polyethylenephthalate (PET), polytetrafluoroethylene (PTFE), polyvinylchloride (PVC), polyvinylidene fluoride (PVDF), polybutyleneterephthalate (PBT), fluorinated ethylenepropylene (FEP), and perfluoralkoxyalkane (PFA).

10. The microfluidic device of claim 1, further comprising a filter between the storage chamber and the fluid passage.

11. The microfluidic device of claim 1, wherein the fluid passage is hydrophilic-treated or hydrophobic-treated to control a flow rate of the sample fluid.

12. The microfluidic device of claim 1, further comprising a valve part having an internal surface which has a greater width than that of the fluid passage or which is hydrophobic-treated.

13. The microfluidic device of claim 12, wherein the valve part is located at least one end of the detection chamber.
